(19) United States
(12) Patent Application Publication
(10) Pub. No.: US 2017/0213245 A1
(43) Pub. Date: Jul. 27, 2017

(54) SELECTING CONTENT FOR ONLINE SYSTEM USERS BASED ON USER INTERACTIONS WITH THIRD PARTY APPLICATIONS

(71) Applicant: Facebook, Inc., Menlo Park, CA (US)

(72) Inventors: David Charles Whitney, Castro Valley, CA (US); Tarun Kartikaye Sharma, Mountain View, CA (US)

(21) Appl. No.: 15/006,806

(22) Filed: Jan. 26, 2016

(51) Int. Cl. G06Q 30/02; H04L 29/08

(52) U.S. Cl. CPC G06Q 30/0255; H04L 67/22; H04L 67/306; H04L 67/20; G06Q 30/0277; G06Q 30/0275

(57) ABSTRACT

An online system stores information identifying interactions by online system users with an application provided by a third party system. The application includes a tracking mechanism specifying one or more interactions with the application. When a user performs a specified interaction with the application via a client device, the tracking mechanism communicates information describing the performed interaction from the client device to the online system. The online system stores interactions by the user with the application and generates one or more aggregations of interactions with the application that are communicated to the third party system. Each aggregation is associated with specific characteristics and identifies interactions by users having the specific characteristics with the application. Based on characteristics of users, the third party system may provide the online system with instructions for generating bid amounts for content associated with the advertisement to use when the online system selects content.

### BACKGROUND

This disclosure relates generally to online systems, and more specifically to selecting content for presentation to users of an online system.

An online system, such as a social networking system, allows users to connect to and communicate with other users of the online system. Users create profiles on an online system that are tied to their identities and include information about the users, such as interests and demographic information. The users may be individuals or entities such as corporations or charities. Content items are presented to various users by the online system to encourage users to interact with the online system.

Additionally, many online systems commonly allow users (e.g., businesses) to sponsor presentation of content on an online system to gain public attention for a user's products or services or to persuade other users to take an action regarding the user's products or services. Content for which the online system receives compensation in exchange for presenting to users is referred to as “sponsored content.” Many online systems receive compensation from a user for presenting online system users with certain types of sponsored content provided by the user. Frequently, online systems charge a user for each presentation of sponsored content to an online system user or for each interaction with sponsored content by an online system user. For example, an online system receives compensation from an entity each time a content item provided by the user is displayed to another user on the online system or each time another user is presented with a content item on the online system and interacts with the content item (e.g., selects a link included in the content item), or each time another user performs another action after being presented with the content item.

Sponsored content presented by an online system may identify an application associated with a third party system to encourage online system users to install the application on client devices or to perform interactions with the application. The third party system associated with the application may then obtain revenue from online system users installing the application or interacting with the application. For example, the third party system sponsors content presented to users of the online system identifying a product to purchase via the application, such as an item for use when interacting with the application.

While online systems may maintain information describing actions performed by their users, conventional online systems are limited to maintaining information describing actions performed by users through the online system or actions communicated to the online system for logging by third party systems. For example, a conventional online system stores interactions between its users and content presented by the online system. However, interactions by online system users with applications generate significant revenue for third party systems associated with the applications. Conventional online systems do not capture these interactions with applications, preventing conventional online systems from providing certain characteristics, such as demographic information, of online system users interacting with applications to third party systems associated with applications that would allow the third party systems to more effectively identify online system users interacting with the applications.

### SUMMARY

An online system receives information describing interactions by users of the online system with an application provided by a third party system and executing on client devices associated with the users. The application includes a tracking mechanism including instructions that are executed by a client device executing the application when a user performs one or more interactions with the application provided by the third party system. When the instructions in the tracking mechanism are executed, information identifying the one or more interactions with the application is communicated from the client device to the online system. In various embodiments, the third party system specifies one or more interactions in the tracking mechanism so the tracking mechanism communicates information identifying a user when the user performs one or more of the specified interactions with the application. Example interactions specified by the third party system in the tracking mechanism include: installing the application, accessing the application via a client device, purchasing a product via the application, adding a product to an online shopping cart maintained by the application, viewing content via the application, adding a product to a list of products associated with the user by the application, subscribing to a service provided by the third party system via the application, communicating with one or more other users via the application, and sharing content provided by the application with another user.

When the user performs an interaction specified by the tracking mechanism with the application provided by the third party system via a client device, the client device executes instructions in the tracking mechanism that communicate information describing the interaction to the online system. Information communicated to the online system identifies the interaction, and may also identify content within the application involved in the interaction (e.g., a product, a content item, a service, etc.). As an example, the application includes an application programming interface call or other mechanism included in the application by the third party system that identifies an interaction with the application. In some embodiments, the application programming interface call is included in a software development kit or other set of instructions provided to the third party system by the online system. When the user performs the interaction specified by the application programming interface call with the content provided by the third party system via the client device, the client device executes the application programming interface call and communicates information describing the interaction to the online system.

Based on information received from the client device executing the application including the tracking mechanism, the online system retrieves information identifying the user who performed the interaction described by the information received from the tracking mechanism. To prevent the third party system from obtaining information identifying the user, the online system retrieves user identifying information associated with the user by the online system and stored on the client device on which the interaction was performed. In some embodiments, the tracking mechanism obtains user identifying information from an application executing on the client device associated with the online system and communicates the user identifying information to the online system along with information describing the interaction. For example, the tracking mechanism retrieves obfuscated (e.g., a hashed) user identifying information associated with the user by the online system and stored on the client device. Hence, the online system may retrieve user identifying information from obfuscated information identifying the user to the online system included in the information describing the interaction with the application.

The online system stores the information describing the interaction with the application provided by the third party system received from the tracking mechanism in association with the user identifying information for the user who performed the interaction. For example, the online system identifies a user profile associated with the user identifying information and stores the information describing the interaction with the content provided by the third party system in association with the user profile. As various users interact with the application provided by the third party system, the online system stores information associated with the users identifying their interactions with the application provided by the third party system received via one or more tracking mechanisms included in the application. Communicating information describing users' interactions with the application provided by the third party system to the online system allows the online system to associate interactions with the application with online system users without providing information identifying the users to the third party system.

To allow the third party system providing the application to more accurately identify users of the online system who frequently interact with the application, the online system generates an aggregation of interactions with the application by various online system users. The aggregation of interactions includes characteristics of users who performed various interactions with the application, but does not include information uniquely identifying users. In some embodiments, the online system generates multiple aggregations of interactions with each aggregation identifying interactions performed by users of the online system having one or more specific characteristics. For example, the online system generates an aggregation including interactions with the application by users associated with a specific location, an aggregation including interactions with the application by users having ages within a specific age range, an aggregation including interactions with the application by users having a specific gender, an aggregation including interactions with the application by users associated with client devices executing a specific operating system, or an aggregation including interactions with the application by users associated with a specific type of client device. An aggregation of interactions with the application may identify a number of various types of interactions with the application by users having the one or more specific characteristics. The online system communicates the generated one or more aggregations to the third party system providing the application, allowing the third party system to identify characteristics of users who performed different interactions with the application provided by the third party system. Communicating aggregations identifying interactions with the application performed by users having different characteristics to the third party system allows the third party system to identify how online system users with different characteristics interact with the application. For example, the online system communicates at least a threshold number of aggregations to the third party system, with each aggregation identifying interactions with the application by users of the online system having different characteristics, allowing a user associated with the third party system to more thoroughly analyze interactions with the application by online system users having different characteristics.

Based on the one or more aggregations, the third party system may determine instructions for determining a bid amount for an advertisement request (“ad request”) associated with the application in a selection process for users having characteristics matching the one or more characteristics of users in an aggregation. For example, the third party system determines a value for the aggregation based on interactions with the application identified by the aggregation. In various embodiments, the third party system associates various weights with different interactions in an aggregation and determines the value for the aggregation by applying weights to numbers of occurrences of various interactions in the aggregation corresponding to the weights and combining the numbers of occurrences of the various interactions after application of the weights. The third party system may associate different weights for an interaction with different aggregations. Hence, the third party system may associate a weight with an interaction in an aggregation and associate an alternative weight with the interaction in an alternative aggregation. As different aggregations are associated with different characteristics of users, the third party system may differently weight interactions with the application when performed by users having different characteristics.

In one embodiment, the third party system determines instructions for generating a bid amount for evaluating an advertisement request (“ad request”) associated with the application for presentation to a user based on a value for an aggregation including the user and a predicted number of times the user will interact with the application and transmits the instructions to the online system. When including the ad request associated with the application in a selection process for the user, the online system determines the predicted number of times the user will interact with the application based on information maintained by the online system and determine the bid amount for the ad request associated with the application from the predicted number of times the user will interact with the application and the instructions from the third party system. One or more selection processes selecting content for presentation to the user by the online system determine whether to present an advertisement from the ad request associated with the application to the user based at least in part on the determined bid amount.

The third party system may provide the online system with instructions for generating a bid amount for an ad request associated with the online system without receiving the one or more aggregations of interactions with the application. For example, the third party system transmits values for interactions with the application performed by users having different characteristics to the online system, which determines a bid amount for an ad request associated with the advertisement in a selection process for a user based on the values for the interactions and likelihoods of the user performing one or more of the interactions with the application. However, instructions for determining a bid amount transmitted from the third party system to the online system may specify any suitable manner of determining the bid amount. For example, the third party system identifies a budget and a minimum return on investment for presenting advertisements from ad requests associated with the application or a maximum time to recover the budget from presenting advertisements from ad requests associated with the application. Alternatively, the online system determines bid amounts for ad requests associated with the application in a selection process for a user based on an expected value to the online system of the user based on values associated with different interactions with the application specified by the online system and likelihoods of the user performing different interactions with the application based on information associated with the user by the online system. If the online system determines a bid amount for an ad request associated with the application, the third party system may transmit instructions to the online system for determining the bid amount, and the online system subsequently determines the bid amount for the ad request associated with the application based on the instructions received from the third party system.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an interaction diagram of a method for providing a third party system with information describing interactions by online system users with an application provided by the third party system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

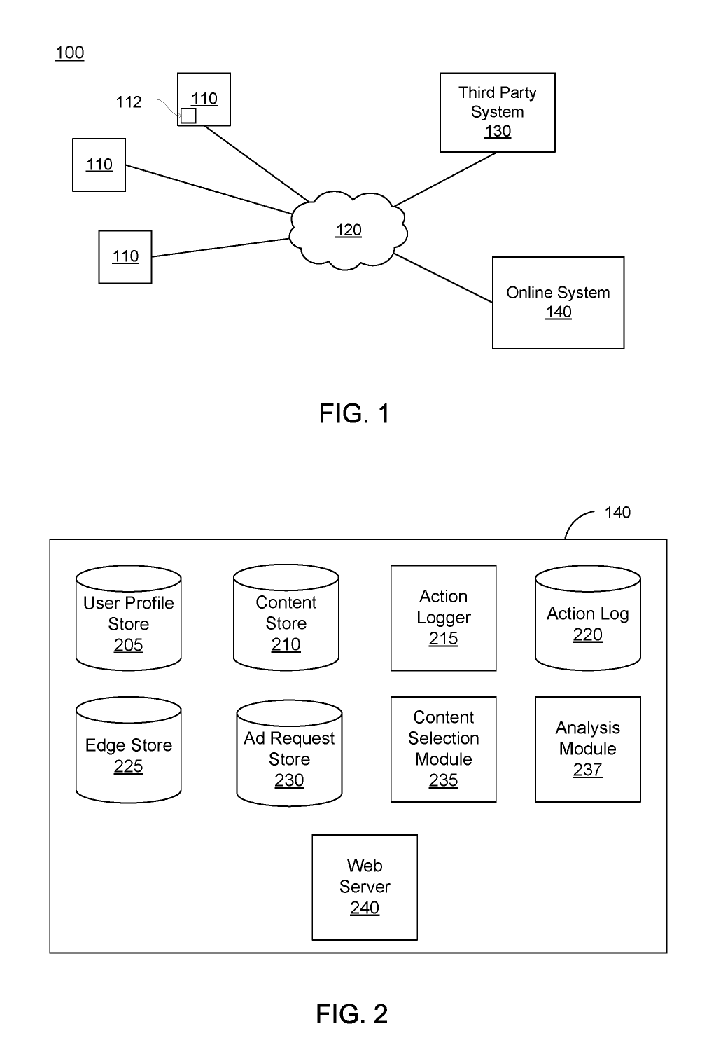

FIG. 1 is a block diagram of a system environment 100 for an online system 140, such as a social networking system. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing an application 112 for execution by a client device 110 or communicating data to client devices 110 for use by the application 112 executing on the client device. In other embodiments, a third party system 130 provides content or other information for presentation via a client device 110. A third party system 130 may also communicate information to the online system 140, such as advertisements, content, or information about the application 112 provided by the third party system 130.

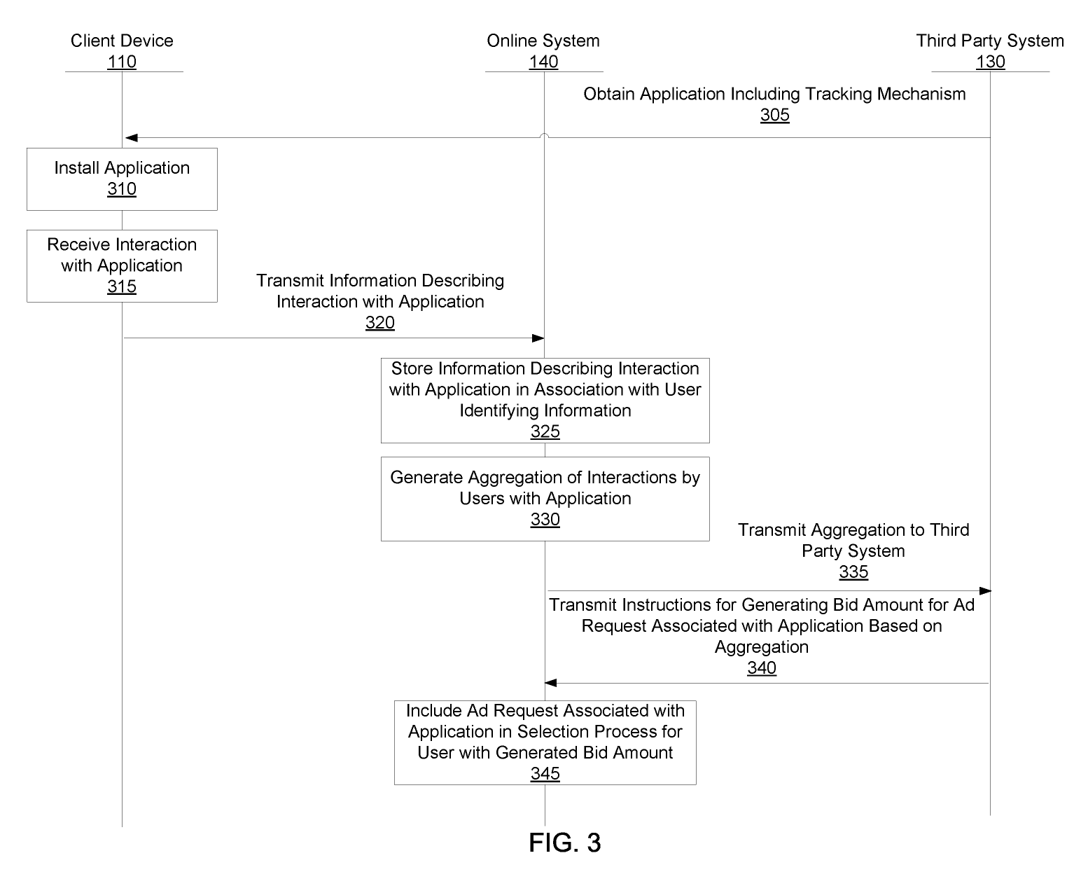

In some embodiments, a third party system 130 includes a tracking mechanism in the application 112 provided by the third party system 130 and executing on a client device 110. The tracking mechanism is instructions that, when executed by the application 112 executed by the client device 110, cause the client device 110 to communicate information describing interactions by a user of the online system 140 with the application 112 to the online system 140. In various embodiments, the tracking mechanism specifies one or more interactions in the tracking mechanism, so the application 112 executes the tracking mechanism and communicates information to the online system 140 when the user performs one or more of the specified interactions with the application. In various embodiments, the tracking mechanism communicates information identifying a user when the user performs one or more of the specified interactions with the application and identifying the one or more specified interactions performed by the user. As further described below in conjunction with FIGS. 2 and 3, the online system 140 maintains information describing user interactions with the application 112 in association with a user of the online system 140 who performed the interactions with the application 112. For example, the online system 140 stores information associated with a user identifying the application 112 and identifying interactions with the application 112 by the user identified by the tracking mechanism. The tracking mechanism may be an application program interface (API) call or other mechanism that is invoked by the application during execution. In some embodiments, the online system 140 provides the API call to a third party system 130 providing the application via a software development kit (SDK).

FIG. 2 is a block diagram of an architecture of the online system 140. For example, the online system 140 is a social networking system. The online system 140 shown in FIG. 2 includes a user profile store 205, a content store 210, an action logger 215, an action log 220, an edge store 225, an advertisement request (“ad request”) store 230, a content selection module 235, an analysis module 237, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. As an example, content provided by a third party system 130 to users of the online system may be identified along with information identifying an online system user 140 by information received by the online system 140, and the action logger 215 logs information identifying the content provided by the third party system 130 in the action log 220 in association with the identified user of the online system 140. For example, the action logger 215 logs information describing interactions between a user of the online system 140 and an application 112 provided by a third party system 130 and executing on a client device 110 based on information communicated to the online system 140 by a tracking mechanism, such an application programming interface call, included in the application 112. The tracking mechanism may communicate information to the online system 140 identifying one or more interactions with the application 112 by a user and information identifying the user to the online system 120, and the action logger 215 stores information identifying the application 112 and the interactions with the application by the user 112 in association with the user, as further described below in conjunction with FIG. 3.

Additionally, the action logger 215 logs information interactions between online system users and advertisements presented to the online system users. For example, information describing a number of times a user of the online system 140 clicked on an advertisement or completed a purchase through interacting with an advertisement is logged by the action logger 215 in association with information identifying the user; times associated with the interactions may also be stored in association with information identifying the user and identifying the advertisement. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items (including advertisements), and any other suitable interactions. Additional examples of interactions with objects on the online system 140 that are included in the action log 220 include: commenting on a photo album, communicating with a user, establishing a connection with an object, joining an event, joining a group, creating an event, installing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Similarly, a third party system 130 may include a tracking mechanism in content provided by the third party system 130. When instructions included in the tracking mechanism are executed by a client device 110, the client device 110 communicates information describing one or more interactions with content provided by the third party system 130 by a user to the online system 140. The online system 140 retrieves user identifying information associated with the user by the online system 140 and stored on the client device 110 and stores the information describing the user's interactions with the content provided by the third party system 130 in association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge included in the edge store 225 may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content, also referred to as an “advertisement” and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items eligible for presentation to the user may include advertisements from ad requests or other content items associated with bid amounts. The content selection module 235 uses the bid amounts associated with ad requests when selecting content for presentation to the user. In various embodiments, the content selection module 235 determines an expected value associated with various ad requests (or other content items) based on their bid amounts and selects content items associated with a maximum expected value or associated with at least a threshold expected value for presentation. An expected value associated with an ad request or with a content item represents an expected amount of compensation to the online system 140 for presenting advertisement content from the ad request or for presenting the content item. For example, the expected value associated with an ad request is a product of the ad request's bid amount and a likelihood of the user interacting with the ad content from the ad request. The content selection module 235 may rank ad requests based on their associated bid amounts and select ad requests having at least a threshold position in the ranking for presentation to the user. In some embodiments, the content selection module 235 ranks both content items not associated with bid amounts and ad requests in a unified ranking based on bid amounts associated with ad requests and measures of relevance associated with content items and with ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 235 receives a request to present a feed of content to a user of the online system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the user. For example, information describing actions associated with other users connected to the user or other data associated with users connected to the user is retrieved and used to select content items, such as content items describing actions associated with one or more of the other users. Additionally, one or more advertisement requests (“ad requests”) may be retrieved from the ad request store 230. The retrieved stories, ad requests, or other content items, are analyzed by the content selection module 235 to identify candidate content items, including ad requests, eligible for presentation to the user. For example, content items associated with users who not connected to the user or content items associated with users for whom the user has less than a threshold affinity are discarded as candidate content items. Based on various criteria, the content selection module 235 selects one or more of the content items or ad requests identified as candidate content for presentation to the user. The selected content items or advertisements from selected ad requests are included in a feed of content that is presented to the user. For example, the feed of content includes at least a threshold number of content items describing actions associated with users connected to the user via the online system 140.

In various embodiments, the content selection module 235 presents content to a user through a feed including a plurality of content items selected for presentation to the user. One or more advertisements may also be included in the feed. The content selection module 235 may also determine the order in which selected content items or advertisements are presented via the feed. For example, the content selection module 235 orders content items or advertisements in the feed based on likelihoods of the user interacting with various content items or advertisements.

The analysis module 237 analyzes information stored in the action log 225 describing interactions by online system users with the application 112 provided by the third party system 130 and executing on client devices 110. In various embodiments, the analysis module 237 generates an aggregation identifying interactions performed with the application 112 by users of the online system 140 having one or more specific characteristics. For example, the analysis module 237 generates an aggregation identifying interactions with the application 112 by users of the online system 140 having a specific gender or by users of the online system 140 associated with a specific location. An aggregation generated by the analysis module 237 may identify a number of various interactions with the application 112 within a particular time interval by users having the one or more specific characteristics associated with the aggregation, but does not include information uniquely identifying the users having the one or more specific characteristics. In some embodiments, the analysis module 237 generates multiple aggregations that each identify interactions with the application 112 performed by users having different specific characteristics. For example, the analysis module 237 generates an aggregation including interactions with the application 112 by users associated with a specific location, an aggregation including interactions with the application 112 by users having ages within a specific age range, an aggregation including interactions with the application 112 by users having a specific gender, an aggregation including interactions with the application 112 by users associated with client devices 110 executing a specific operating system, or an aggregation including interactions with the application 112 by users associated with a specific type of client device. One or more aggregations generated by the analysis module 237 may be communicated to the third party system 130 providing the application 112, allowing the third party system 130 to identify characteristics of users performing different interactions with the application 112. As further described below in conjunction with FIG. 3, the third party system 130 may modify ad requests associated with the application 112 provided to the online system 140 based on one or more aggregations from the analysis module 237.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, analyzed information, instant messages, queued messages (e.g., email), text messages, short message service (SMS) messages, or messages sent using any other suitable messaging technique. A user may send a request to the web server 240 to upload information (e.g., images or videos) that is stored in the content store 210. Additionally, the web server 240 may provide application programming interface (API) functionality to send data directly to native client device operating systems, such as IOS®, ANDROID™, WEBOS®, or BlackberryOS.

Storing Interactions by Online System Users with Content Presented by Third Party Systems

FIG. 3 is an interaction diagram of one embodiment of a method for providing a third party system 130 with information describing interactions by online system users with an application 112 provided by the third party system 130. In other embodiments, the method may include different and/or additional steps than those shown in FIG. 3. Additionally, steps of the method may be performed in different orders than the order described in conjunction with FIG. 3 in various embodiments.

A user of the online system 140 obtains 305 an application 112 from a third party system 130. The application 112 includes a tracking mechanism, comprising instructions that, when executed by a client device 110 executing the application 112 communicate information describing interactions with the application 112 to the online system 140. For example, the tracking mechanism is an application programming interface call included in the application from a software development kit provided to the third party system 130 by the online system 140. In various embodiments, the tracking mechanism identifies one or more interactions with the application 112 provided by the third party system 130 and includes instructions that are executed by the client device 110 when a user performs one or more of the identified interactions with the application 112 provided by the third party system 130. Example interactions specified by the third party system 130 in the tracking mechanism include: installing the application 112, accessing the application 112 via a client device 110, purchasing a product via the application 112, adding a product to an online shopping cart maintained by the application 112, viewing content via the application 112, adding a product to a list of products associated with the user by the application 112, subscribing to a service provided by the third party system 130 via the application 112, communicating with one or more other users via the application 112, and sharing content provided by the application 112 with another user. However, in various embodiments, the tracking mechanism identifies any suitable interaction in the tracking mechanism, so the instructions in the tracking mechanism may be executed when the user performs any suitable interaction with application 112 provided by the third party system 130 that is identified by the tracking mechanism. When the user performs an interaction with the application 112 matching an interaction identified by the tracking mechanism, the client device 110 executes the tracking mechanism (e.g., the application programming interface call) and communicates the information describing the interaction with the application 112 to the online system 140.

The client device 110 installs 310 the application 112 obtained 305 from the third party system 130. When the client device 110 receives 315 an interaction with the application 112 provided by the third party system 130 that matches an interaction specified by the tracking mechanism included in the application 112, the client device 110 executes instructions in the tracking mechanism that transmit 320 information describing the interaction with the application 112 provided by the third party system 130 to the online system 140. Information transmitted 320 to the online system 140 identifies the interaction with the application 112. In some embodiments, the tracking mechanism transmits additional information associated with the interaction to the online system 140. For example, the tracking mechanism transmits information identifying content presented by the application 112 involved in the interaction. As a particular example, if the received interaction was a purchase of a product via the application 112, the transmitted information identifies the purchase as well as an identifier of the purchased product. Various methods may be used to transmit 320 the information describing the interaction with the content provided by the third party system 130 to the inline system. For example, after receiving 315 the interaction matching an interaction specified by the tracking mechanism, the client device 110 executes instruction in the tracking mechanism that execute an application programming interface call communicating information to the online system 140 from the client device 110; hence, the third party system 130 may include an application programming interface call in an application provided by the third party system 130 that communicates information describing one or more interactions identified by the application programming interface call to the online system 140. Additionally, the online system 140 retrieves information identifying the user who performed the interaction described by the information transmitted 320 by the tracking mechanism.

To prevent the third party system 130 from receiving information identifying the user who performed the interaction, the online system 140 retrieves user identifying information associated with the user by the online system 140 and stores 325 the information describing the interaction in association with the user identifying information. For example, the tracking mechanism obtains user identifying information from an application executing on the client device 110 and associated with the online system 140 and communicates the user identifying information to the online system 140 along with information describing the interaction. For example, the tracking mechanism retrieves obfuscated (e.g., a hashed) user identifying information associated with the user by the online system 140 and stored on the client device 110 and transmits 320 the obfuscated user identifying information to the online system 140 along with the information describing the received interaction with the application 112 provided by the third party system 130. The online system 140 retrieves the user identifying information from the obfuscated user identifying information and stores 325 the information describing the interaction in association with the retrieved user identifying information to maintain a record of interactions by the user with the application 112. For example, the online system 140 identifies a user profile associated with the user identifying information and stores 325 the information describing the interaction with the application 112 from the tracking mechanism in association with the user profile. Hence, as various users perform interactions with the application 112 provided by the third party system 130 matching interactions specified by one or more tracking mechanisms included in the content provided by the third party system 130, the online system 140 stores 325 information associated with the users identifying their interactions with content provided by the third party system 130, allowing the online system 140 to maintain interactions between the users and the content provided by the third party system 130 without providing information identifying the users to the third party system 130. For example, the third party system 130 is unable to retrieve information maintained by the online system 140 in association with the users who performed the interactions, while the online system 140 maintains a record of the interactions by online system users with the application 112 provided by the third party system 130.

The online system 140 analyzes stored information describing interactions by various users with the application 112 provided by the third party system 130 and executing on client devices 110 and generates 330 one or more aggregations identifying interactions performed with the application 112 by users of the online system 140. Each aggregation identifies interactions with the application 112 by users having one or more specific characteristics. For example, an aggregation identifies interactions with the application 112 by users of the online system 140 having a specific gender or by users of the online system 140 associated with a specific location. In various embodiments, an aggregation generated 330 by the online system 140 identifies a number of various interactions with the application 112 within a particular time interval by users having the one or more specific characteristics associated with the aggregation, but does not include information uniquely identifying the users having the one or more specific characteristics. For example, an aggregation identifies a number of times users with ages in a specific age range and associated with a specific location accessed the application 112 and a number of times the users with ages in the specific age range and associated with the specific location purchased a product via the application 112. Different aggregations generated by the online system 140 identify interactions performed by users with different specific characteristics. For example, the online system 140 generates an aggregation including interactions with the application 112 by users associated with a specific location, an aggregation including interactions with the application 112 by users having ages within a specific age range, an aggregation including interactions with the application 112 by users having a specific gender, an aggregation including interactions with the application 112 by users associated with client devices 110 executing a specific operating system, or an aggregation including interactions with the application 112 by users associated with a specific type of client device 110 (e.g., a specific model of the client device 110, a form factor of the client device 110—mobile communication device, desktop device, laptop device, tablet device, etc.).

One or more of the aggregations are transmitted 335 from the online system 140 to the third party system 130 providing the application 112, allowing the third party system 130 to identify characteristics of users performing different interactions with the application 112. As the aggregations do not include information allowing the third party system 130 to identify users of the online system 140 who performed the interactions identified by the aggregations, transmitting 335 one or more of the aggregations to the third party system 130 allows the online system 140 to maintain user privacy while also allowing the third party system 130 to analyze interactions with the application by online system users. Although the aggregations do not include information allowing the third party system 130 to identify users of the online system 140, different aggregations describe interactions with the application 112 by users having different characteristics, allowing a user of the third party system 130 to evaluate interactions with the application 112 by online system 140 with different characteristics by analyzing different aggregations. For example, the third party system 130 identifies locations or age ranges associated with online system users who perform a maximum number of a certain interaction with the application or who more frequently perform the certain interaction relative to users associated with other locations or age ranges based on interactions identified by aggregations corresponding to different locations or age ranges. By analyzing the one or more aggregations, the third party system 130 may provide the online system 140 with advertisement requests (“ad requests”) having targeting criteria specifying characteristics of users who are most likely to perform one or more particular interactions with the application 112 when presented with advertisements from the ad requests. Hence, transmitting 335 aggregations to the third party system 130 allows the third party system 130 to analyze how online system users with characteristics corresponding to different aggregations interact with the application 112, allowing the third party system 130 to better identify online system users likely to perform one or more particular interactions with the application 112 to be presented with advertisements from ad requests.

In some embodiments, the third party system 130 determines instructions for determining a bid amount for an ad request associated with the application 112 in a selection process performed by the online system 140 for users having characteristics matching the one or more characteristics of users in an aggregation. For example, the third party system 130 determines a value for the aggregation based on interactions with the application 112 identified by the aggregation. In various embodiments, the third party system 130 associates various weights with different interactions in an aggregation and determines the value for the aggregation based on weights associated with various interactions in the aggregation and a number of occurrences of the various interactions identified by the aggregation. For example, the third party system 130 applies a weight associated with an interaction with the application 112 to a number of occurrences of the interaction identified by the aggregation for various interactions and determines the value for the aggregation by combining the numbers of occurrences of the various interactions identified by the aggregation after application of the weights. The third party system 130 may associate different weights for an interaction with different aggregations, allowing the third party system 130 to different weight interactions with the application 112 by users having different characteristics. Hence, the third party system 130 may associate a weight with an interaction identified by an aggregation and associate an alternative weight with the interaction identified by an alternative aggregation.

The third party system 130 may determine and transmit 340 instructions for the online system 140 to generate a bid amount for evaluating an advertisement request (“ad request”) associated with the application 112 for presentation to a user having one or more characteristics matching characteristics associated with an aggregation based on a value for the aggregation determined by the third party system 130 and a number of times the user will interact with the application predicted by the online system 140. However, the third party system 130 may transmit 340 any suitable instructions for determining a bid amount for evaluating an ad request associated with the application 112 for presentation to a user. For example, the third party system 130 transmits 340 instructions to the online system 140 identifying a budget and a minimum return on investment for presenting advertisements from ad requests associated with the application 112 or a maximum time to recover the budget from presenting advertisements from ad requests associated with the application 112, and the online system 140 determines bid amounts for ad requests associated with the application 112 based on the instructions.

When including the ad request associated with the application in a selection process for the user, the online system 140 determines the predicted number of times the user will interact with the application based on information maintained by the online system 140 and determine the bid amount for the ad request associated with the application from the predicted number of times the user will interact with the application and the instructions from the third party system 130. One or more selection processes selecting content for presentation to the user by the online system 140 determine whether to present an advertisement from the ad request associated with the application to the user based at least in part on the determined bid amount.

When the online system 140 identifies an opportunity to present one or more advertisements to a user having characteristics matching characteristics associated with an aggregation, the online system 140 determines a bid amount for an ad request associated with the application 112 based on the instructions received from the third party system 130. For example, instructions received from the third party system 130 identify values for different interactions with the application 112 when performed by users having different characteristics, and the online system 140 determines a bid amount for an ad request associated with the advertisement in a selection process for a user based on the values for the interactions and likelihoods of the user performing one or more of the interactions with the application. As another example, the received instructions include a value for an aggregation including the user and one or more weights for modifying the value based on a predicted amount of a specific interaction with the application 112 (e.g., accessing the application); the online system 140 determines the predicted amount of the specific interaction by the user based on information associated with the user by the online system 140 and determines the bid amount for an ad request by modifying the value for the aggregation including the user based on the predicted amount of the specific interaction. However, instructions for determining a bid amount transmitted 340 from the third party system 130 to the online system 140 may specify any suitable manner of determining the bid amount. The online system 140 includes 345 the ad request associated with the application 112 in one or more selection processes selecting the one or more advertisements for presentation to the user with the determined bid amount for the ad request. As further described above in conjunction with FIG. 2, a selection process selects the one or more advertisements based at least part on the bid amounts associated with ad requests including various advertisements.

Alternatively, the online system 140 determines bid amounts for ad requests associated with the application 112 in a selection process for a user based on an expected value to the online system 140 of the user based on values associated with different interactions with the application 112 specified by the online system and likelihoods of the user performing different interactions with the application 112 based on information associated with the user by the online system 112. The online system 140 subsequently includes 345 the ad requests in one or more selection processes in association with the determined bid amounts. If the online system 140 determines a bid amount for an ad request associated with the application 112, the third party system 130 may transmit 340 instructions to the online system 140 for determining the bid amount, and the online system 140 subsequently determines the bid amount for the ad request associated with the application 112 based on the instructions received from the third party system 130. Hence, the third party system 130 may specify bid amounts for ad request associated with the application 112 that are based at least in part on interactions by various online system users with the application 112.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information from a client device describing one or more interactions by a user of an online system with an application executing on the client device, the application including a tracking mechanism configured to communicate information describing the one or more interactions by the user to the online system in response to the application receiving the one or more interactions by the user;
retrieving user identifying information from the client device, the user identifying information identifying the user to the online system;
storing information at the online system describing the one or more interactions by the user with the application executing on the client device in association with the user identifying information identifying the user to the online system;
generating an aggregation of interactions by users of the online system with the application based on stored information at the online system describing one or more interactions by users with the application, the aggregation associated with one or more specific characteristics of users of the online system; and
communicating the aggregation to a third party system associated with the application.

2. The method of claim 1, wherein the one or more interactions by the user of the online system with the application executing on the client device match interactions specified by the tracking mechanism.

3. The method of claim 1, wherein an interaction by the user of the online system with the application executing on the client device is selected from a group consisting of: accessing the application, installing the application, installing the application, purchasing a product via the application, adding the product to an online shopping cart maintained by the application, viewing content via the application, adding a product to a list of products associated with the user by the application, subscribing to a service provided by the third party system via the application, communicating with one or more other users via the application, sharing content provided by the application with another user, and any combination thereof.

4. The method of claim 1, wherein generating the aggregation of interactions by users of the online system with the application based on stored information at the online system describing one or more interactions by users with the application comprises:
generating a plurality of aggregations, each aggregation associated with one or more specific characteristics of users of the online system and identifying one or more interactions with the application by the users having the one or more specific characteristics.

5. The method of claim 1, wherein the specific characteristic of users associated with the online system is selected from a group consisting of: a specific location, a specific age range, a specific gender, an operating system executed by the client device, a specific type of the client device, and any combination thereof.

6. The method of claim 1, wherein retrieving user identifying information from the client device comprises:
retrieving information identifying the user to the online system previously stored on the client device by the online system.

7. The method of claim 1, further comprising:
receiving instructions from the third party system for generating one or more bid amounts associated with one or more advertisement requests associated with the application for presentation to the user based on the user having characteristics matching the specific characteristics associated with the aggregation.

8. The method of claim 7, further comprising:
generating a bid amount for an advertisement request associated with the application using the received instructions in response to identifying an opportunity to present one or more advertisements from ad requests to the user; and
including the advertisement request associated with the application in association with the generated bid amount in one or more selection processes selecting the one or more advertisements from ad requests for presentation to the user.

9. The method of claim 7, wherein the received instructions from the third party system for generating the one or more bid amounts identify a value to the third party system of the aggregation and modification of the value based on a predicted amount of interaction with the application by the user determined by the online system.

10. The method of claim 7, wherein the received instructions from the third party system for generating the one or more bid amounts identify a budget and a minimum return on investment for presenting advertisements from advertisement requests associated with the application to one or more users of the online system.

11. The method of claim 7, wherein the received instructions from the third party system for generating the one or more bid amounts identify a budget and a maximum time to recover the budget from presenting advertisements from ad requests associated with the application to one or more users of the online system.

12. The method of claim 1, further comprising:
generating a bid amount for an advertisement request associated with the application based on values associated with different interactions with the application by the online system and likelihoods of the user performing the different interactions with the application based on information associated with the user by the online system in response to identifying an opportunity to present one or more advertisements from ad requests to the user; and
including the advertisement request associated with the application in association with the generated bid amount in one or more selection processes selecting the one or more advertisements from ad requests for presentation to the user.

13. A computer program product comprising a computer readable storage medium having instructions encoded thereon that, when executed by a processor, cause the processor to:
receive information from a client device describing one or more interactions by a user of an online system with an application executing on the client device, the application including a tracking mechanism configured to communicate information describing the one or more interactions by the user to the online system in response to the application receiving the one or more interactions by the user;
retrieve user identifying information from the client device, the user identifying information identifying the user to the online system;
store information at the online system describing the one or more interactions by the user with the application executing on the client device in association with the user identifying information identifying the user to the online system;
generate an aggregation of interactions by users of the online system with the application based on stored information at the online system describing one or more interactions by users with the application, the aggregation associated with one or more specific characteristics of users of the online system; and
communicate the aggregation to a third party system associated with the application.

14. The computer program product of claim 13, wherein the one or more interactions by the user of the online system with the application executing on the client device match interactions specified by the tracking mechanism.

15. The computer program product of claim 13, wherein an interaction by the user of the online system with the application executing on the client device is selected from a group consisting of: accessing the application, installing the application, installing the application, purchasing a product via the application, adding the product to an online shopping cart maintained by the application, viewing content via the application, adding a product to a list of products associated with the user by the application, subscribing to a service provided by the third party system via the application, communicating with one or more other users via the application, sharing content provided by the application with another user, and any combination thereof.

16. The computer program product of claim 13, wherein generate the aggregation of interactions by users of the online system with the application based on stored information at the online system describing one or more interactions by users with the application comprises:
generate a plurality of aggregations, each aggregation associated with one or more specific characteristics of users of the online system and identifying one or more interactions with the application by the users having the one or more specific characteristics.

17. The computer program product of claim 13, wherein the specific characteristic of users associated with the online system is selected from a group consisting of: a specific location, a specific age range, a specific gender, an operating system executed by the client device, a specific type of the client device, and any combination thereof.

18. The computer program product of claim 13, wherein the computer readable storage medium further has instructions encoded thereon that, when executed by the processor, cause the processor to:
receive instructions from the third party system for generating one or more bid amounts associated with one or more advertisement requests associated with the application for presentation to the user based on the user having characteristics matching the specific characteristics associated with the aggregation.

19. The computer program product of claim 18, wherein the received instructions from the third party system for generating the one or more bid amounts identify a budget and a minimum return on investment for presenting advertisements from advertisement requests associated with the application to one or more users of the online system.

20. The computer program product of claim 18, wherein the computer readable storage medium further has instructions encoded thereon that, when executed by the processor, cause the processor to:
generate a bid amount for an advertisement request associated with the application using the received instructions in response to identifying an opportunity to present one or more advertisements from ad requests to the user; and
include the advertisement request associated with the application in association with the generated bid amount in one or more selection processes selecting the one or more advertisements from ad requests for presentation to the user.
